(19) United States
(12) Patent Application Publication
(10) Pub. No.: US 2023/0399193 A1
(43) Pub. Date: Dec. 14, 2023

(54) CABLE CAROUSEL FOR HEAVY-DUTY ELECTRIC CABLE OR UMBILICAL

(71) Applicant: Mammoet Holding B.V., Utrecht (NL)

(72) Inventors: Wessel Helmens, Utrecht (NL); Johannes Marinus Adrianus van Wees, Utrecht (NL)

(21) Appl. No.: 18/453,083

(22) Filed: Aug. 21, 2023

Related U.S. Application Data
(63) Continuation of application No. PCT/NL2022/050124, filed on Mar. 7, 2022.

(30) Foreign Application Priority Data
Mar. 9, 2021 (NL) 2027729

(51) Int. Cl. B65H 49/28; B65H 49/32; B63B 25/24

(52) U.S. Cl. CPC B65H 49/28; B65H 49/321; B63B 25/24; B65H 2701/33; B65H 2701/34

(57) ABSTRACT

A cable carousel including a support grid and upstanding supports on the support grid that confine a region in which a heavy-duty electric cable or umbilical can be received and supported by the support grid. The upstanding supports are placeable on the support grid at preselected positions defining both an inner barrier and an outer barrier so as to tailor the cable carousel to a dimension between the inner and outer barriers to store a predetermined length of the electric cable or umbilical. The cable carousel may also include shores connecting the inner barrier to the support grid.

### CROSS-REFERENCE TO RELATED APPLICATIONS

This application is a continuation of International Application No. PCT/NL2022/050124, entitled “CABLE CAROUSEL FOR HEAVY-DUTY ELECTRIC CABLE OR UMBILICAL”, filed Mar. 7, 2022, which claims priority to Netherlands Patent Application No. 2027729, entitled “CABLE CAROUSEL FOR HEAVY-DUTY ELECTRIC CABLE OR UMBILICAL”, filed Mar. 9, 2021, and the specifications and claims thereof are incorporated herein by reference.

### BACKGROUND OF THE INVENTION

### Field of the Invention

The invention relates to a cable carousel comprising a support grid and upstanding supports on the support grid that confine a region in which a heavy-duty electric cable or umbilical can be received and supported by the support grid, wherein the upstanding supports are placeable on the support grid at preselected positions defining both an inner barrier and an outer barrier so as to tailor the cable carousel to a dimension between said inner and outer barriers which is necessary and sufficient to store a predetermined length of said cable. The cable carousel is provided with shores connecting the inner barrier to the support grid.

### Background Art

A cable carousel is disclosed in EP 3 260 751 and is used when a heavy-duty electric cable is to be provided between an offshore windmill installation and an intermediate electrical transfer station, as well as when such a heavy-duty electric cable is to be provided between such an electrical transfer station and an onshore connection to the electric grid.

The cable carousel of EP 3 260 751 can be tailored with dimensions to suit the particular heavy-duty electric cable that has to be supported and stored in or on the cable carousel. The costs of an offshore windmill park are for the larger part attributable to the costs of the heavy-duty electric cables to be installed and the cable carousels to be used for transport, the cost of shipping the cable carousel with the cable, and the labour costs of putting the heavy-duty electric cables in place.

### BRIEF SUMMARY OF THE INVENTION

When a heavy-duty electric cable or umbilical is to be collected from a manufacturing site overseas, a ship with an empty cable carousel has to travel to the manufacturing site, upon arrival at the manufacturing site the electric cable or umbilical must be wound onto the cable carousel and embarked on the ship, and the ship can then travel back with the carousel provided with the electric cable or umbilical to the intended destination where the heavy-duty electric cable or umbilical is intended to be used. All in all this is an expensive routine since it involves much time to embark the cable carousel with the electric cable or umbilical on the ship, the traveling time of the ship, and in general the idle time of the ship. This idle time not only relates to the time required for embarking the cable carousel with the cable, but also for disembarking the cable carousel with the cable after having arrived at the destination where the heavy electric cable or umbilical must be put to use.

It is an object of the invention to make embarking and disembarking of the cable carousel with the cable an easier task which can be accomplished quicker.

Embodiments of the present invention are directed to a cable carousel in accordance with one or more of the appended claims.

In a first aspect of the invention, the shores are connectable to the inner barrier at one of a series of preselected positions above the support grid. This enables, next to a course adjustment of the length of the shores themselves, a finetuning to the required dimensions of the cable carousel. This enables tailoring of the cable carousel to the length of the cable to be transported. Moreover, the footprint area that is required for placing the carousel with the cable on the vessel remains limited to the very least that is required for this purpose.

In another aspect of the invention which can be applied independently or in combination with the feature mentioned in the previous paragraph, reinforcement beams are provided within the support grid, which beams are regularly distributed in a star pattern and are connected to a central connecting point within the support grid, which is positioned on a virtual vertical axis which is encircled by the inner and outer barriers. This construction is particularly suitable for transport of very heavy cables due to their extended lengths, and which are accordingly more heavy than normal.

It is preferred that the shores are regularly distributed in a region confined by the inner barrier. This provides a more or less uniform security provision that fixes the cable carousel with the cable in all directions, so that transport the vessel motions of pitch, jaw and heave will not adversely affect the security of mounting of the cable carousel with the cable on the vessel.

It is further preferred that the shores are extendable and fixable at a preselected length. This enables, again with limited means, that the cable carousel to be used for transporting a cable can have different dimensions tailored to the length of the cable at hand.

In another aspect of the invention which can be applied in combination with the preamble of claim 1, and wherein the shores connect to a connecting organ which is centrally provided within the cable carousel, and wherein the connecting organ is connectable or connected to the support grid, it is preferred that the connecting organ and the support grid are each provided with an aperture, wherein the aperture of the connecting organ and the aperture of the support grid are alignable, and said apertures are equipped to receive a locking pile. By applying this feature, the cable carousel with the cable stored in the carousel can be easily secured.

In still another aspect of the invention which can be applied in combination with the preamble of claim 1, the support grid is equipped to cooperate with a yoke of a transport vessel, which is arranged to receive the locking pile that is provided through the aligned apertures of the connecting organ and the support grid. This promotes the robustness of the construction. All horizontal forces that occur during sea transport are absorbed by the relatively flexible construction with the inner barrier and the shores. These forces are eventually discharged through the locking pile in the middle to the pontoon or transport vessel on which the support grid is provided. Accordingly, the invention is also embodied in a vessel provided with a yoke which is equipped to receive the locking pile that is provided through the aligned apertures of the connecting organ and the support grid.

As already mentioned above, in a particular aspect of the invention reinforcement beams are provided within the support grid that are regularly distributed in a star pattern, and said star-pattern-beams are connected to a central connecting point within the support grid positioned on a virtual vertical axis which is encircled by the inner and outer barriers. This construction is particularly suitable for heavy cables due to their extensive lengths. It is then preferable that the central connecting point is positioned in line with and below the connecting organ which is provided on the support grid.

To promote the sturdiness and the robustness of the construction it is further preferable that the inner barrier is connected with horizontal beams to the connecting organ immediately above the support grid.

Advantageously the horizontal beams are provided in a star pattern above the support grid, corresponding to the star pattern of the reinforcement beams within the support grid.

It is further preferred that the horizontal beams have a preselected length and that their connection with the inner barrier and the connecting organ is dismountable. This supports that the dimensions of the cable carousel can be accommodated to different dimensions of cables.

Preferably the inner barrier is provided with horizontal bars that are parallel to and distant from the support grid, and connected to the locking pile mounted fixed or removably in the connecting organ. This further promotes the sturdiness and the robustness of the construction.

It is also preferred that the horizontal bars are extendable and fixable at a preselected length. This also supports the adjustment of the cable carousel to different dimensions of the cable to be transported.

Preferably the support grid is assembled from bottom supports, wherein said bottom supports and/or the upstanding supports may be assembled together with dimensions not exceeding the dimensions of a standard sea container. This enables that the respective parts of the cable carousel can be easily shipped at low costs, without need to reserve a particular ship for this purpose wherein unused space is occupied by the cable carousel as is the case in the prior art. Only when the parts of the cable carousel of the invention has arrived at the manufacturing site of the heavy-duty electric cable or umbilical, the cable carousel can be assembled and the electric cable or umbilical can be provided thereon, and only after that time it is necessary to avail of a standard cargo vessel or transportation barge for transporting the cable carousel with the electric cable or umbilical to its destination.

Preferably the support grid is embodied by a series of load carrying movable vehicles, preferably self-propelled modular trailers. This makes winding and unwinding of the heavy-duty electric cable or umbilical a relatively easy task by the movable vehicles appropriately driving around in circles.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims. Any reference to a “first” or other “aspects” or “embodiments” of the present invention are not intended to give preference to any particular embodiment as a best mode or best version of the invention.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIGS. 1A, 1B and 1C are illustrations showing an assembled cable carousel according to an embodiment of the present invention in an isometric view, a top view and a front view respectively, but without electrical cable or umbilical;

FIG. 2 is an illustration showing the assembled cable carousel of FIG. 1 supporting an electrical cable or an umbilical;

FIG. 3 is an illustration showing an example of a self-propelled modular trailer which may form a part of the support grid of the cable carousel according to an embodiment of the present invention;

FIG. 4 is an illustration showing a stack of bottom supports which can be assembled into the support grid, wherein the stack of bottom supports is assembled with twist locks and has dimensions not exceeding those of a standard sea container;

FIG. 5 is an illustration showing a detail of a twist lock connecting two bottom supports;

FIG. 6 is an illustration showing an assembled cable carousel according to an embodiment of the present invention placed on a series of adjacent self-propelled modular trailers;

FIG. 7 is an illustration showing a detail of a twist lock;

FIG. 8 is an illustration showing an isometric view at a radial section taken from and through the center of the cable carousel according to an embodiment of the present invention;

FIGS. 9A and 9B are illustrations showing a top view and sectional view respectively, each pertaining to a cable carousel according to an embodiment of the present invention with a minimum radius of an inner barrier of the cable carousel;

FIGS. 10A and 10B are illustrations showing a top view and sectional view respectively, each pertaining to a cable carousel according to an embodiment of the present invention with a maximum radius of an inner barrier of the cable carousel;

FIG. 11 is an illustration showing a detail of a central portion of a cable carousel according to an embodiment of the present invention; and

FIG. 12 is an illustration showing a further detail of a central portion of a cable carousel according to an embodiment of the present invention.

### DETAILED DESCRIPTION OF THE INVENTION

Whenever in the figures the same reference numerals are applied, these numerals refer to the same parts.

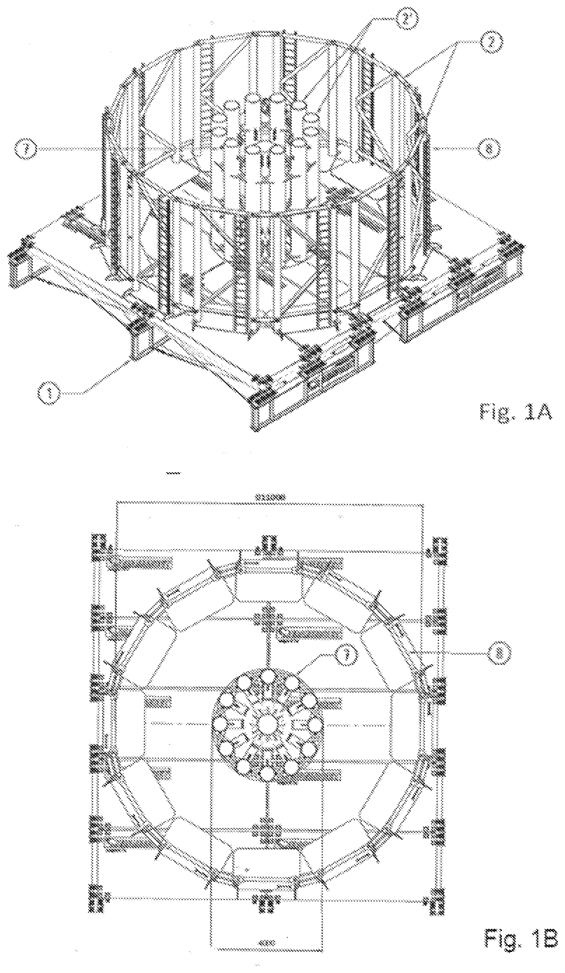

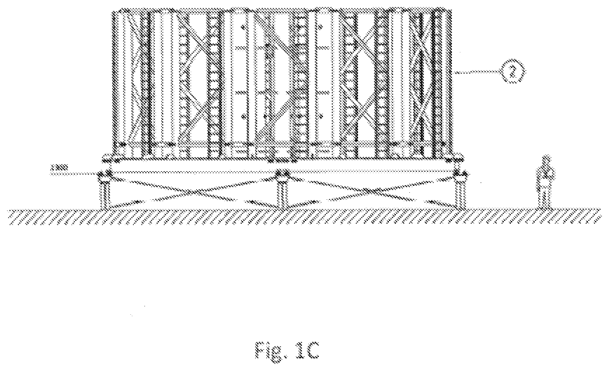

In FIGS. 1A-1C an overview picture is provided of a cable carousel for heavy-duty electric cable or umbilical, wherein said cable carousel comprises support grid 1 and upstanding supports 2, 2′ on support grid 1 at preselected positions defining both inner barrier 7 and outer barrier 8 so as to tailor the cable carousel to a dimension between said inner and outer barriers 7, 8 which is necessary and sufficient to store a predetermined length of electric cable or umbilical (not shown) to be received and supported by support grid 1.

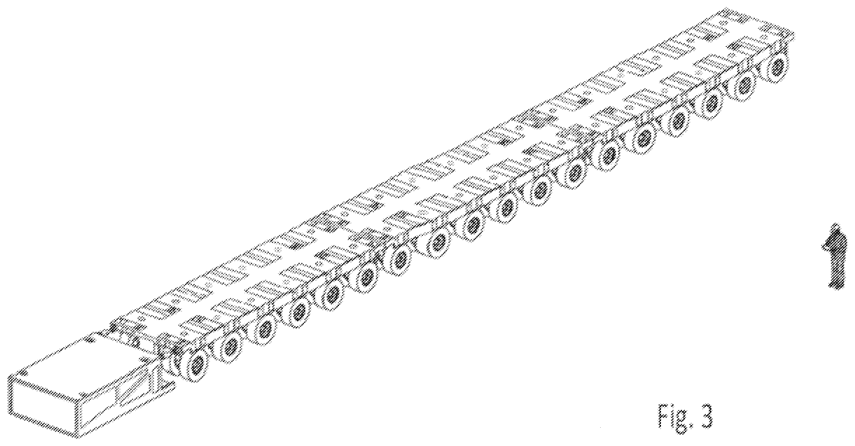

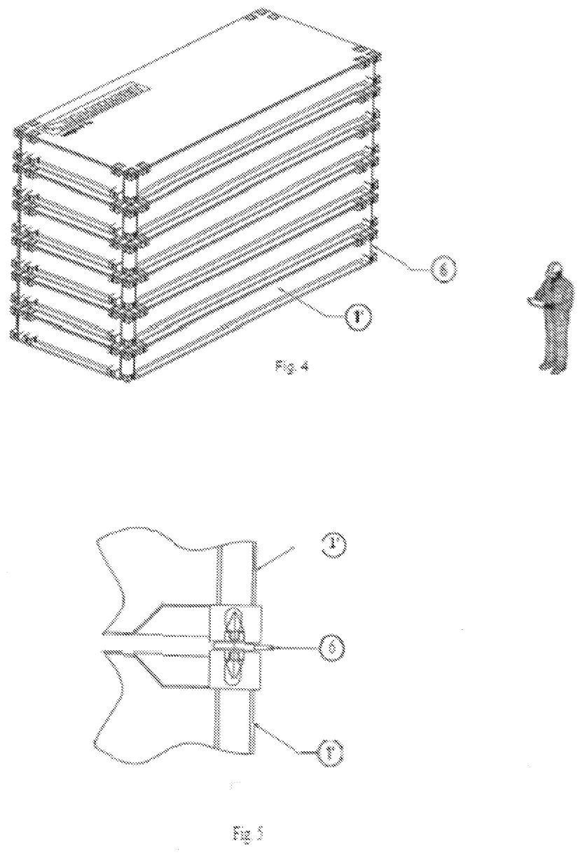

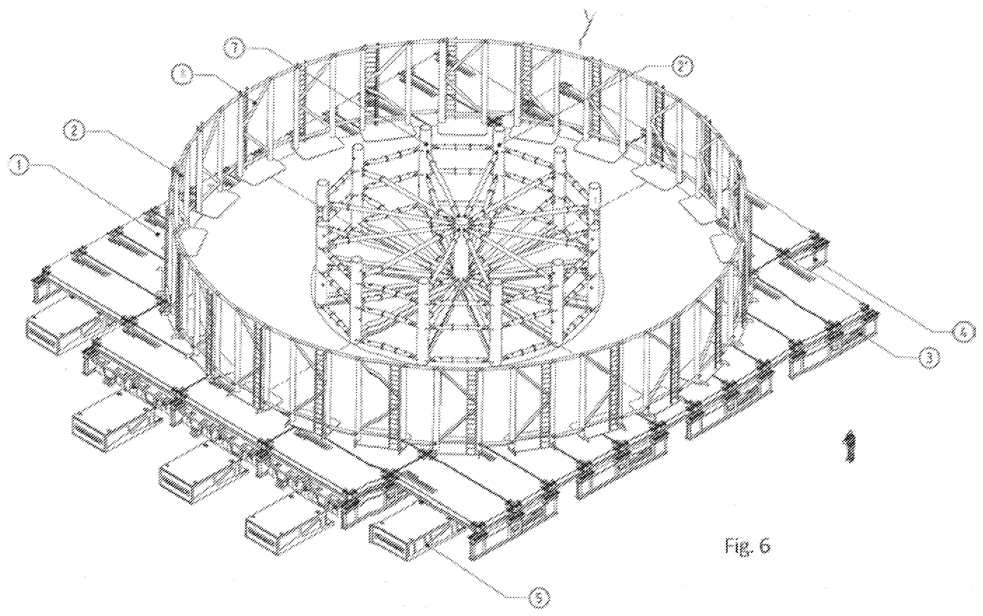

FIG. 6 shows the cable carousel of the invention while it is supported by a series of load carrying movable vehicles, which are preferably self-propelled modular trailers 5. FIG. 3 shows an example of a single one of such a self-propelled modular trailer.

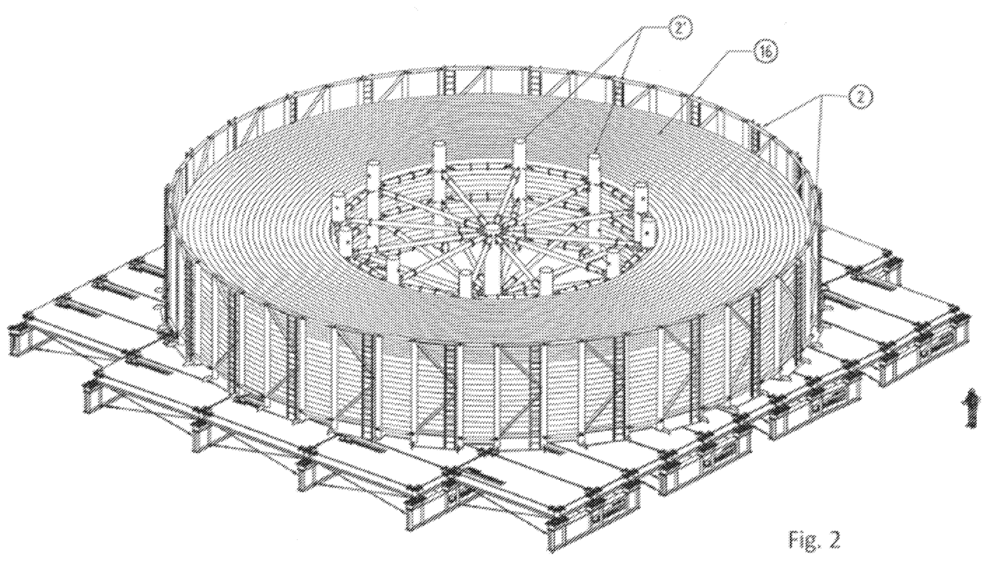

FIG. 2 depicts the cable carousel of the invention in which a heavy-duty electric cable or umbilical 16 is received.

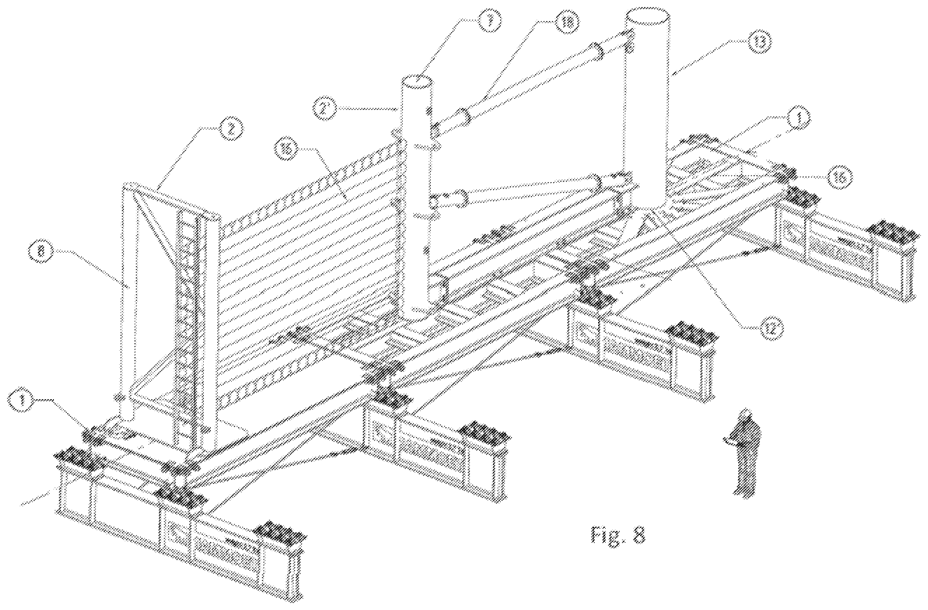

Upstanding supports 2, 2′ that are provided on support grid 1—also see FIG. 8—define a circular region between an inner circumference in the middle of support grid 1 which is provided by upstanding supports 2′ placed near the center of support grid 1 which define inner barrier 7, and a series of upstanding supports 2 which define outer barrier 8 of a circular region between said barriers. In this circular region between inner barrier 7 and outer barrier 8 heavy-duty electric cable or umbilical 16 can be stored.

Upstanding supports 2, 2′ are removably mounted on support grid 1. It will thus be clear that upstanding supports 2, 2′ are placeable on support grid 1 at preselected positions so as to tailor the cable carousel of the invention to a dimension which is necessary and sufficient to store a predetermined length of the heavy-duty electric cable or umbilical.

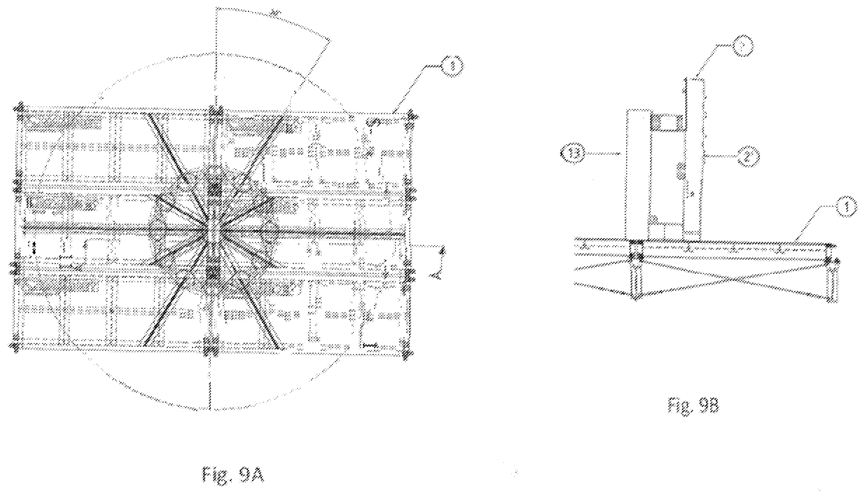

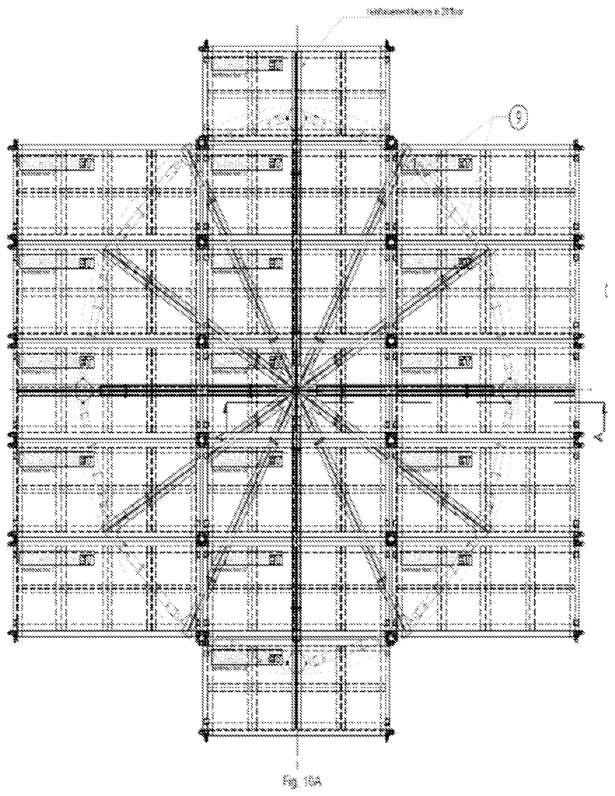

FIGS. 9A and 9B show an embodiment wherein the cable carousel is having a minimal radius of inner barrier 7 with reference to central locking pile 13 which may be fixedly or removably mounted on support grid 1.

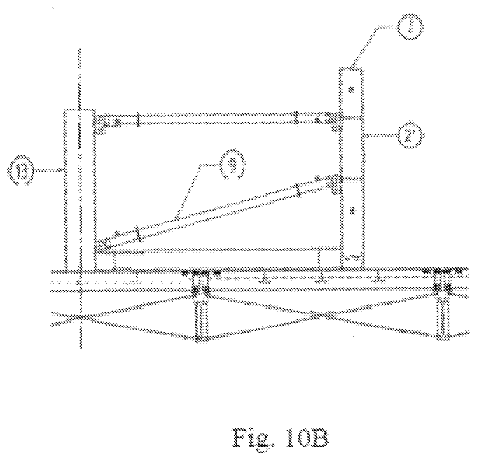

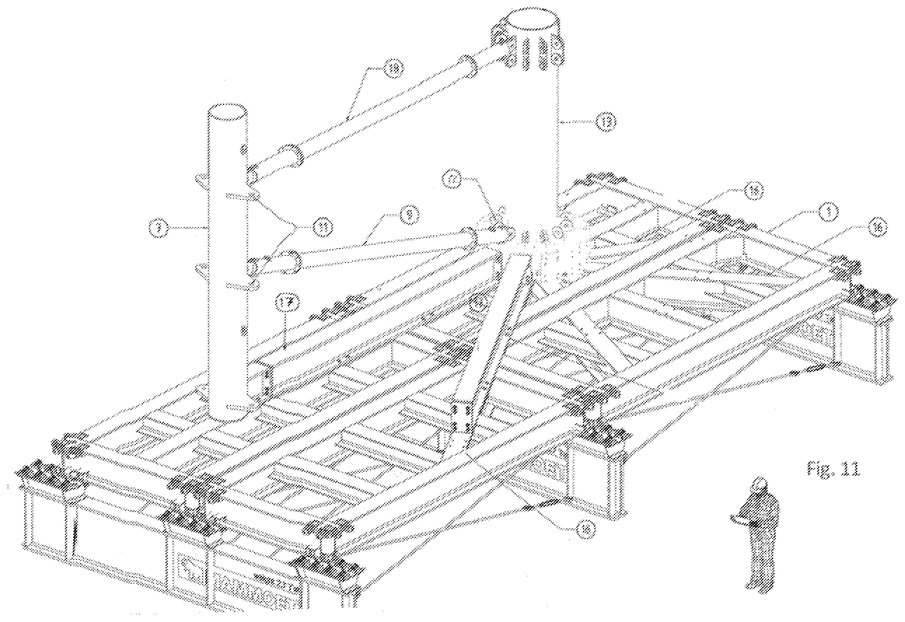

FIGS. 10A and 10B show an embodiment wherein the cable carousel is having a maximum radius of inner barrier 7 with reference to central locking pile 13 which may be fixedly or removably mounted on support grid 1.

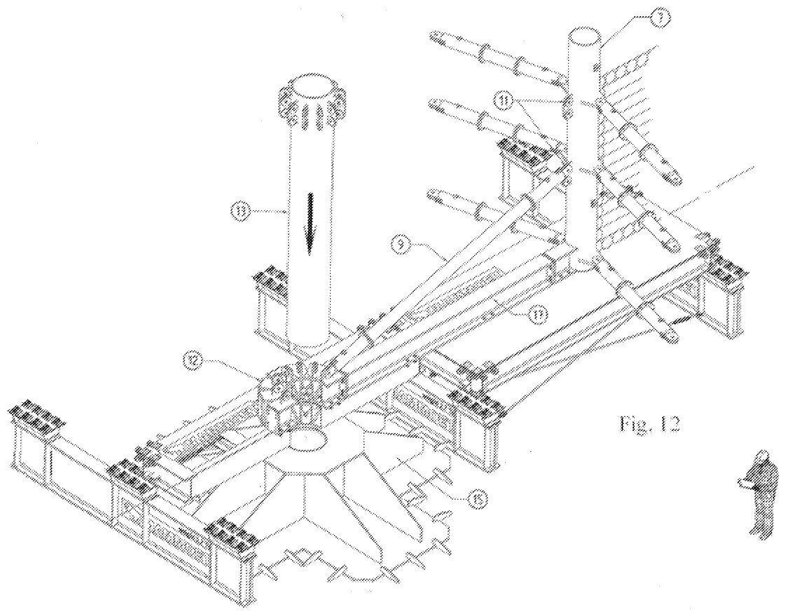

FIGS. 8 and 11 show that within support grid 1 reinforcement beams 16 are provided. These reinforcement beams 16 are regularly distributed in a star pattern. Star-pattern-beams 16 are connected to central connecting point 12′ (FIG. 8) within support grid 1. Central connecting point 12′ is positioned on a virtual vertical axis centrally in the cable carrousel of the invention. The vertical axis is centrally positioned and encircled by inner and outer barriers 7, 8. In particular, central connecting point 12′ is positioned in line with and below connecting organ 12 which is provided on support grid 1 of the cable carousel. This may be best understood with reference to FIG. 11 showing a number of reinforcement beams 16 and connecting organ 12, below and around which reinforcement beams 16 are provided in a regular starshaped pattern.

The adaptability of the cable carousel of the invention to different dimensions and lengths of the electrical cable to be transported, while the cable carousel of the invention still provides a reliable and robust storage facility will be explained hereinafter with reference to FIGS. 8, 11 and 12. These FIGS. 8, 11 and 12 show that inner barrier 7 is connected with horizontal beams 17 immediately above support grid 1 to connecting organ 12.

Horizontal beams 17 are also provided in a star pattern and are placed correspondingly above the star pattern of reinforcement beams 16 within support grid 1.

Horizontal beams 17 have a preselected length and their connection with inner barrier 7 and connecting organ 12 is dismountable.

FIGS. 8 and 11 further show that inner barrier 7 is provided with horizontal bars 18 that are parallel to and distant from support grid 1, and that horizontal bars 18 are connected to locking pile 13 which can be fixed or removably mounted in connecting organ 12. Horizontal bars 18 are extendable and fixable at a preselected length. Locking pile 13 will be further discussed hereinafter.

In one aspect, a cable carousel of the invention may be provided with shores 9 connecting inner barrier 7 to support grid 1. FIGS. 2 and 10A depict that shores 9 are regularly distributed in the inner region confined by inner barrier 7. Preferably shores 9 are extendable and fixable at a preselected length. Further, shores 9 are connectable to inner barrier 7 at one of a series of preselected positions 11 above support grid 1.

It is most clearly shown in FIGS. 11 and 12 that shores 9 connect to a connecting organ 12 which is centrally provided within the cable carousel on support grid 1. Connecting organ 12 is in turn connectable or connected to support grid 1 (not shown in FIG. 12). Connecting organ 12 and support grid 1 are each provided with an aperture, wherein the aperture of connecting organ 12 and the aperture of support grid 1 are alignable, and said apertures are equipped to receive locking pile 13.

FIG. 12 further shows that below support grid 1 of cable carrousel, yoke 15 is provided which forms part of a transport vessel. Yoke 15 is equipped to receive locking pile 13 that is provided through the aligned apertures of connecting organ 12 and support grid 1. All horizontal forces that occur during sea transport of the cable carousel and cable are thus absorbed by the relatively flexible construction of the carousel with inner barrier 7 and shores 9. These forces are eventually discharged through locking pile 13 and transferred to yoke 15 of the pontoon or transport vessel on which support grid 1 is provided.

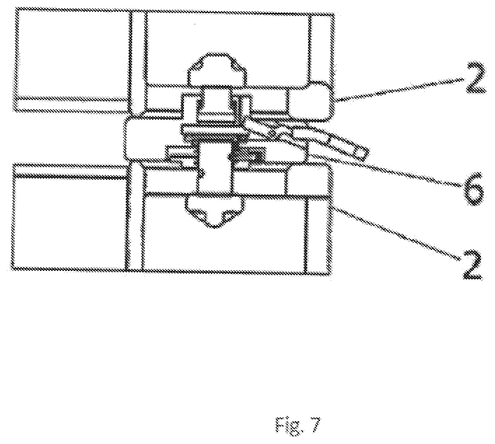

In another aspect of the invention, preferably support grid 1 is assembled from separable bottom supports 1′, and bottom supports 1′ and/or upstanding side supports 2 may be assembled together with dimensions not exceeding the dimensions of a standard sea container. An example thereof is shown in FIG. 4 which shows a stack of bottom supports 1′ forming assembly parts of the support grid 1, and which bottom supports 1′ assembled together with twist locks 6 provide a stack of bottom supports 1′ with dimensions not exceeding those of a standard sea container. A detail of the connection between two bottom supports 1′ with twist lock 6 is shown in FIG. 5. FIG. 7 shows twist lock 6.

Embodiments of the present invention can include every combination of features that are disclosed herein independently from each other. Although the invention has been discussed in the foregoing with reference to an exemplary embodiment of the cable carousel of the invention, the invention is not restricted to this particular embodiment which can be varied in many ways without departing from the invention. The discussed exemplary embodiment shall therefore not be used to construe the appended claims strictly in accordance therewith. On the contrary the embodiment is merely intended to explain the wording of the appended claims without intent to limit the claims to this exemplary embodiment. The scope of protection of the invention shall therefore be construed in accordance with the appended claims only, wherein a possible ambiguity in the wording of the claims shall be resolved using this exemplary embodiment. The terms, “a”, “an”, “the”, and “said” mean “one or more” unless context explicitly dictates otherwise.

1. A cable carousel comprising:
a support grid and upstanding supports disposed on the support grid that confine a region in which a heavy-duty electric cable or umbilical can be received and supported by the support grid, wherein the upstanding supports are placeable on the support grid at preselected positions defining both an inner barrier and an outer barrier so as to tailor the cable carousel to a dimension between the inner and outer barriers which is necessary and sufficient to store a predetermined length of the cable, wherein the cable carousel comprises shores connecting the inner barrier to the support grid, and the shores are connectable to the inner barrier at one of a series of preselected positions above the support grid.

2. The cable carousel according to claim 1, wherein the shores are regularly distributed in a region confined by the inner barrier.

3. The cable carousel according to claim 1, wherein the shores are extendable and fixable at a preselected length.

4. The cable carousel according to claim 1, wherein:
the shores connect to a connecting organ which is centrally provided within the cable carousel;
the connecting organ is connectable or connected to the support grid; and
the connecting organ and the support grid each comprise an aperture, wherein the aperture of the connecting organ and the aperture of the support grid are alignable, and said apertures are equipped to receive a locking pile which can be fixedly or removably mounted to the connecting organ.

5. The cable carousel according to claim 1, wherein:
the support grid is equipped to cooperate with a yoke of a transport vessel which is arranged to receive the locking pile that is provided through the aligned apertures of the connecting organ and the support grid.

6. The cable carousel according to claim 1, further comprising:
reinforcement beams disposed within the support grid, the reinforcement beams regularly distributed in a star pattern, and which star-pattern-beams are connected to a central connecting point within the support grid and which is positioned on a virtual vertical axis which is encircled by the inner and outer barriers.

7. The cable carousel according to claim 6, wherein the central connecting point is positioned in line with and below the connecting organ disposed on the support grid.

8. The cable carousel according to claim 4, wherein the inner barrier is connected with horizontal beams immediately above the support grid to the connecting organ.

9. The cable carousel according to claim 8, wherein the horizontal beams are disposed in a star pattern above and corresponding to the star pattern of the reinforcement beams within the support grid.

10. The cable carousel according to claim 7, wherein the horizontal beams have a preselected length and their connection with the inner barrier and the connecting organ is dismountable.

11. The cable carousel according to claim 4, further comprising:
horizontal bars disposed on the inner barrier, the horizontal bars parallel to and distant from the support grid, and the horizontal bars are connected to the locking pile mounted in the connecting organ.

12. The cable carousel according to claim 11, wherein the horizontal bars are extendable and fixable at a preselected length.

13. The cable carousel according to claim 1, wherein the support grid is assembled from bottom supports, wherein said bottom supports and/or the upstanding side supports may be assembled together with dimensions not exceeding the dimensions of a standard sea container.

14. The cable carousel according to claim 1, wherein the support grid is provided on a series of load carrying movable vehicles.

15. A vessel provided with a cable carousel according to claim 1, wherein the vessel comprises a yoke equipped to receive the locking pile that is provided through the aligned apertures of the connecting organ and the support grid.

16. The cable carousel according to claim 14, wherein the load carrying movable vehicles comprises at least one self-propelled modular trailer.
